(19) United States
(12) Patent Application Publication
(10) Pub. No.: US 2014/0181307 A1
(43) Pub. Date: Jun. 26, 2014

(54) ROUTING APPARATUS AND METHOD

(71) Applicant: Electronics and Telecommunications Research Institute, Daejeon (KR)

(72) Inventors: Seung-Ik LEE, Daejeon (KR); Jong Hwa YI, Daejeon (KR); Shin Gak KANG, Daejeon (KR)

(21) Appl. No.: 13/910,955

(22) Filed: Jun. 5, 2013

(30) Foreign Application Priority Data
Dec. 21, 2012 (KR) 10-2012-0150170

(51) Int. Cl. H04L 12/947

(52) U.S. Cl. CPC H04L 49/25
USPC 709/226

(57) ABSTRACT

A routing apparatus includes a path setting unit configured to receive a service name-based service request from user equipment (UE), to select a service instance based on the service name, and to establish a service request path; and an interface unit configured to transfer the service request to the service instance along the service request path, and to transfer service data of the service instance to the UE. Further, the path setting unit selects the service instance in accordance with service and network conditions of the service instance.

### CROSS-REFERENCE TO RELATED APPLICATION(S)

The present invention claims priority of Korean Patent Application No. 10-2012-0150170, filed on Dec. 21, 2012, which is incorporated herein by reference.

### FIELD OF THE INVENTION

The present invention relates to a routing apparatus and method and, more particularly, to a routing apparatus and method that can transfer a request for the execution of a service to an optimum service instance in accordance with the conditions of a user or the state of a network using a name representative of the function of the corresponding service in order to execute services that are distributed over the Internet.

### BACKGROUND OF THE INVENTION

In general, Internet systems use an Internet Protocol (IP) address-based network routing apparatus that includes location information. In order to execute an Internet-based service, a routing apparatus transmits an execution request message to a network using an IP address assigned to the corresponding service, and then the network routes the execution request message along the shortest path for the assigned IP address.

FIG. 1 is a diagram illustrating a routing method in the related art.

Referring to FIG. 1, in accordance with the conventional routing method, user equipment (UE) acquires the IP address of a service application server 10 providing a desired service via an out-of-band signal, and requests the corresponding service using the IP address. Then the service application server 10 transmits the data packets of execution result to the UE via routers 20 in response to the corresponding service request. That is, the routers 20 act as conduits that perform host address-based routing.

The conventional routing method is suitable for terminal-to-terminal connection-based packet exchange, but has its limitations with respect to the multiple terminals-to-multiple terminals connection-based provision of service that has been recently applied to social network services (SNSs) and smart phones. The reason for this is that when a UE requests a service, it uses an IP address indicative of the location of a service application server on which the service is installed and executed.

Accordingly, even when a user moves from one location to another and a service application server that provides the same function is present at the user's new location that is closer to the user than the original location, an original service application server cannot be automatically replaced with the service application server at the user's new location unless the user personally selects the service application server at the user's new location. Furthermore, when an existing service is stopped or a network path for the transmission of service is congested, there are limitations with respect to the detection of it on a network.

### SUMMARY OF THE INVENTION

In view of the above, the present invention provides a routing apparatus and method that can transfer a request for the execution of a service to an optimum service instance in accordance with the conditions of a user or the state of a network using a name representative of the function of the corresponding service in order to execute services that are distributed over the Internet.

In accordance with a first aspect of the present invention, there is provided a routing apparatus, including: a path setting unit configured to receive a service name-based service request from user equipment (UE), to select a service instance based on the service name, and to establish a service request path; and an interface unit configured to transfer the service request to the service instance along the service request path, and to transfer service data of the service instance to the UE; wherein the path setting unit selects the service instance in accordance with service and network conditions of the service instance.

Further, the path setting unit may determine whether the service and network conditions satisfy predefined conditions, and then controls the service instance and the service request path.

Further, the routing apparatus may further comprise a service instance management unit configured to group at least one of the service instances which are previously registered in a repository into a service group, map the service name of the service group to one of the service instance, and manage the mapping information.

Further, the repository may store service instance information about the service instance.

Further, the service instance information may include a service instance ID used to identify the service instance, a name of a service group defined for each function of a service provided by the service instance, a functional property and description for the service name, service binding information for the service instance, and service performance indices for the service and the network.

Further, the interface unit may convert the service request in accordance with an interface format of the service instance and provides the converted service request to the service instance, and may convert service results of the service instance in accordance with an interface format of the service group and provide the converted service results to the UE, based on the service binding information.

Further, the routing apparatus may further comprise a service execution management unit configured to cache the service results on the network, and to, if the service request is identical to the cached service results, provide the service results to the UE.

In accordance with a second aspect of the present invention, there is provided a routing method, including: transferring a service request under a service name acquired via a UE; searching for service instances for the service name on a network; selecting at least one from among the found service instances, and transferring the user request; and providing a service provided by the selected service instance, to the UE.

Further, the routing method may further comprise grouping the service instance into a service group, the service instance including at least one previously registered service instance; and mapping the service instance to the service name for the service group.

Further, the selecting service instances may be performed based on conditions of services provided by the service instances, and conditions of the network.

In accordance with the present invention, a customized service can be provided in accordance with a user and network conditions because a service instance which optimizes the service quality is selected and executed for the given service name, and the user can use the service without interruption because a network reacts adaptively.

### BRIEF DESCRIPTION OF THE DRAWINGS

The above and other objects and features of the present invention will become apparent from the following description of embodiments given in conjunction with the accompanying drawings, in which:

FIG. 1 is a diagram illustrating a routing method in the related art;

FIG. 2 is a block diagram illustrating a routing apparatus in accordance with an embodiment of the present invention;

FIG. 3 is a diagram illustrating service binding in accordance with an embodiment of the present invention;

FIG. 4 is a diagram illustrating service instance registration in accordance with an embodiment of the present invention; and

FIGS. 5 to 7 are diagrams illustrating a routing method in accordance with an embodiment of the present invention.

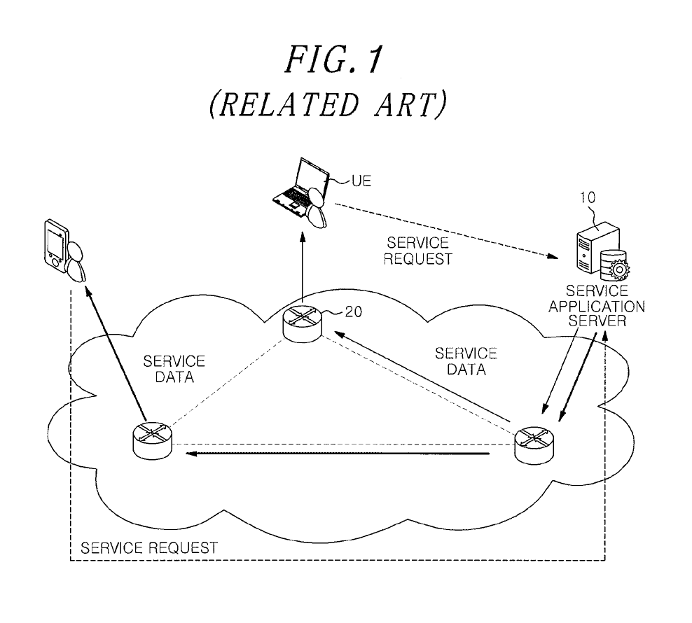

### DETAILED DESCRIPTION OF THE EMBODIMENTS

Embodiments of the present invention will be described in detail below with reference to the accompanying drawings so that those having ordinary knowledge in the art to which the present invention pertains can easily practice the present invention.

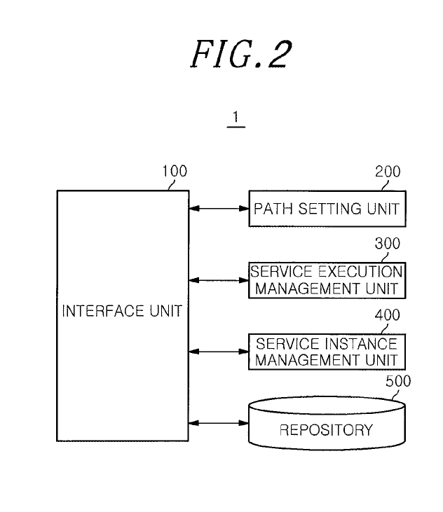

FIG. 2 is a block diagram illustrating a routing apparatus 1 in accordance with an embodiment of the present invention.

Referring to FIG. 2, the routing apparatus 1 in accordance with this embodiment of the present invention includes an interface unit 100, a path setting unit 200, a service execution management unit 300, a service instance management unit 400, and a repository 500.

The interface unit 100 receives a service name-based service request from UE while communicating with the UE. Here, the service name in accordance with an embodiment of the present invention is represented in a previously designated form, and the name of a service group representative of service instances is defined as the service name and then described. The term “service instance” refers to a service component that provides a specific service. A service group includes service instances that are grouped together according to the representative function of services that are provided by the service instances. The interface unit 100 transmits service request data to a corresponding service instance along a path established by the path setting unit 200, receives service data from the service instance, and transmits the service data to the UE.

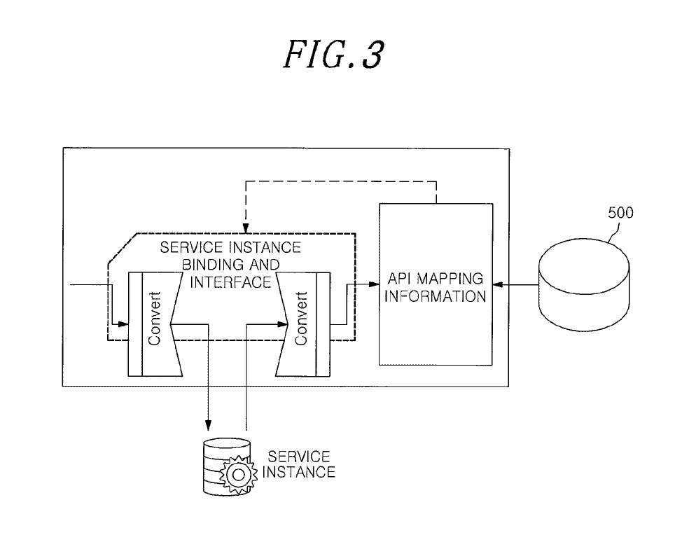

For this purpose, the interface unit 100 performs binding on the service instance using service instance information. That is, as illustrated in FIG. 3, the interface unit 100 converts user request data into a format suitable for the interface of a service group using API mapping information retrieved from the repository 500 and then provides the converted user request data to the service instance, and converts the performance results of the service into a format corresponding to the interface of the service group and then provides the converted performance results of the service to the UE.

The reason for this is that actual binding is enabled via the address of a service instance, but the functional interfaces of a service instance group may not be the same. Accordingly, the interface unit 100 performs the invoking of a service interface or the setting of parameter values, attributable to a service request, in accordance with the property of a service group, but performs an API mapping procedure in order to actually transfer the service request to the service instance.

When the service request is transferred from the UE under a service name, the path setting unit 200 maps a service instance to the corresponding service name, and establishes a service request path to be used to transfer the service request to the mapped service instance.

For this purpose, the path setting unit 200 selects a service instance from a service group corresponding to the service name using service instance information stored in the repository 500, and transfers the service request to the selected service instance. Here, it is preferred that the path setting unit 200 in accordance with this embodiment of the present invention select a service instance optimum for service and network conditions.

That is, the path setting unit 200 determines whether service and network conditions for the selected service instance satisfy predefined conditions. If the service and network conditions for the selected service instance do not satisfy the predefined conditions, the path setting unit 200 selects another optimum service instance, and sets a new service request path. Here, the predefined conditions include a user's movement, a change in the user's state, a change in the state of a network and a change in the state of a service. That is, the user's movement includes a change in the location of the UE, a change in the UE, and a change in the network connected to the UE. Furthermore, the change in the user's state includes a change in the user's temporal/spatial state, and a change in preferences. Moreover, the changes in the network and the service include a connection failure, congestion or burden.

The embodiment of the present invention is not limited thereto. If a service name refers to a composite service that combines two or more component services, the path setting unit 200 may interconnect and combine a plurality of service instances stored in the repository 500 and then transfer a service request. For example, if a service name is a path discovery service in which a map service and a locating service have been combined together, the path setting unit 200 may select a service instance that provides a map service and a service instance that provides a locating service, and transfer a service request.

The service execution management unit 300 manages the service execution results of the selected service instance. More specifically, if a service is provided from the selected service instance to the UE and then executed, the service execution management unit 300 caches data about corresponding service execution results on the network. If a service request transferred from the UE is the same as the data about cached execution results, the service execution management unit 300 does not perform the binding and execution of the corresponding service instance, and performs control and management so that the cached data about service execution results is provided to the UE.

The service instance management unit 400 manages service instance information, previously registered by the application developer or service developer of the service instance in the repository 500, on the network. Here, the service instance information includes a service instance ID configured to identify a service instance, the name of a service group defined for each representative function of a service provided by the service instance, a functional property and description for the service name, service binding information, and service performance indices.

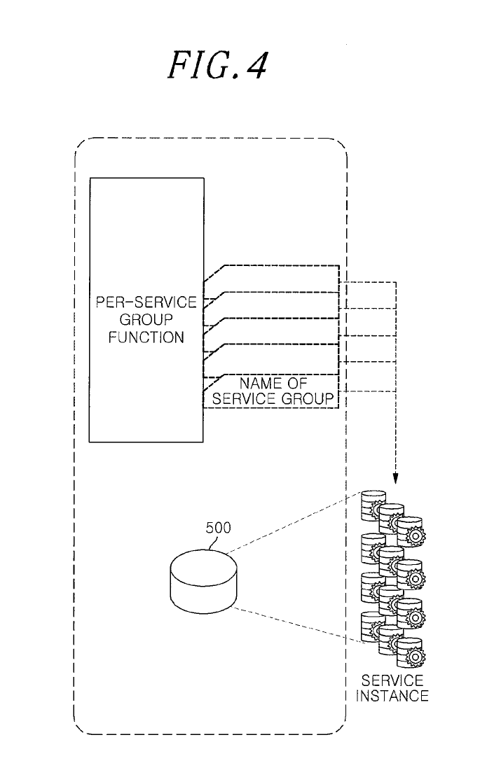

Here, the service instance is mapped to one or more service groups and then registered in the repository 500, as illustrated in FIG. 4. The registered service instance provides application program interface (API) mapping information between interfaces in order to support all the interfaces of the mapped service groups.

Here, a method of mapping service instances to service names may include a method of hierarchically determining service instance IDs based on service names, and a method of performing mapping via a separate apparatus that records relationships between service names and service instance IDs. Furthermore, the service names or service instance IDs may be defined according to the space name type and the description type in various manners.

The following Table 1 illustrates an example of the relationships between service names and service instances.

TABLE 1

| Service | Functional | | Service |
|---|---|---|---|
| name | Property | Interface | instance (ID) |
| online.map | online map | getCurrentArea( ) | Map service A |
| | service | getArea(gps) | (A.online.map) |
| | | | map service B |
| | | | (B.online.map) |
| online.sms | online SMS | sendText(to, msg) | SMS service A |
| | transmission | sendMMS(to, msg) | (A.online.sms) |
| | service | | SMS service B |
| | | | (B.online.sms) |

Here, the service binding information includes a service instance address, such as an IP address or a uniform resource locator (URL), per-service function interface mapping data and a data format. For example, the service binding information may include an interface name, and a parameter format.

The service performance indices include indices for the optimization of Quality of Experience (QoE) and the optimization of network resources at the time when a user receives a service. That is, the service performance indices are used to evaluate the performance of a service that is provided by a service instance based on a user, and service and network conditions. More specifically, the index for the optimization of QoE may include a service area, a service security level, service operation and transfer performance, service durability, service reliability, and a service usage fee.

Here, the service area represents the extent of the distance between a service area and a user, and the service operation and transfer performance represents the performance of the operation and data transmission of a service. The service durability represents whether service can be continuously provided even when the type or state of a terminal or network changes. The service reliability represents whether service can be provided without failure or interruption, and the service usage fee represents a fee that is incurred by the usage of service. Here, the service usage fee includes a fee for the usage of a network that is used to provide the service.

The index for the optimization of network resources may include the localization of service traffic, the optimization of service traffic, the distribution of service load, etc. for the selection of a service. Here, the localization of service traffic represents the extent of locally restricting service traffic, and the optimization of service traffic represents the extent of minimizing the occurrence of the redundant traffic of the same service. The distribution of service represents the extent of distributing the concentration of network and service resources. This embodiment of the present invention is not limited thereto, and various performance indices that evaluate service performance may be used.

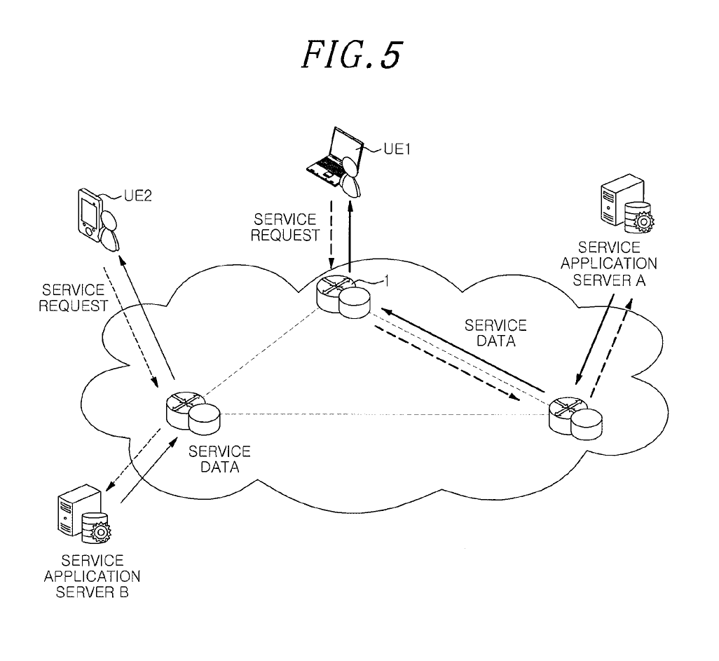

FIGS. 5 to 7 are diagrams illustrating a routing method in accordance with an embodiment of the present invention.

Referring to FIG. 5, first, when a user makes a service request under a service name acquired via UE UE1 or UE2, the path setting unit 200 searches for service instances for the corresponding service name over an infrastructure network. For example, the path setting unit 200 may connect to the infrastructure network, and search service application servers A and B that have been grouped under the same service name.

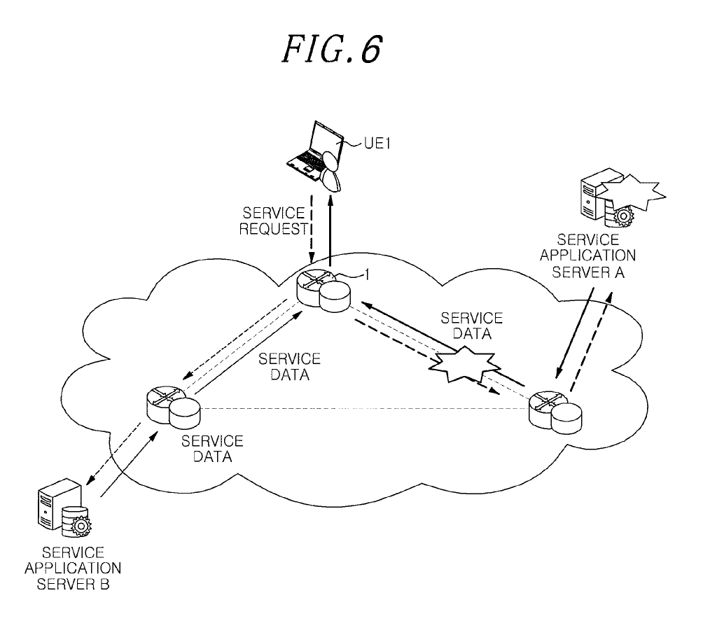

Thereafter, the path setting unit 200 selects a service instance optimum for current conditions, and then transfers the corresponding service request. For example, the path setting unit 200 may select the service application server A closer to the UE UE1 in the case of the UE UE1 and the service application server B in the case of the UE UE2 while taking into consideration the localization of network traffic and a reduction in delay time. Here, as illustrated in FIG. 6, if the path setting unit 200 detects the failure of the service application server A or network while the user is using service via the service application server A, the path setting unit 200 may automatically select and set a service application server on the network again, and then continue to provide the service via the new service application server B.

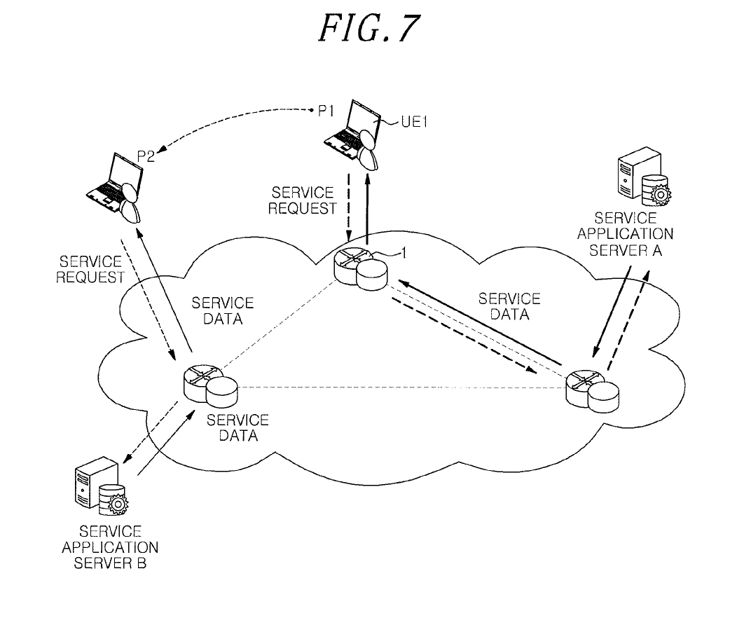

Furthermore, as illustrated in FIG. 7, if the UE UE1 moves from a location P1 to a location P2 while a user is using a service via the service application server A, the path setting unit 200 may automatically select and set the service application server B, closer to the location P2 to which the UE UE1 moves, on the network again, and then continue to provide the service.

As described above, in the routing apparatus and method in accordance with the embodiments of the present invention, a customized service can be provided in accordance with a user and service and network conditions because an optimized service instance is selected and executed using a service name, and the user can use the service without interruption because a network reacts adaptively. Furthermore, the optimized selection of a service is automatically provided to the user, and sales and marketing burden to a service provider can be reduced. Furthermore, a network service provider can create a new business model based on the relay between users and services.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A routing apparatus, comprising:
a path setting unit configured to receive a service name-based service request from user equipment (UE), to select a service instance based on the service name, and to establish a service request path; and
an interface unit configured to transfer the service request to the service instance along the service request path, and to transfer service data of the service instance to the UE;
wherein the path setting unit selects the service instance in accordance with service and network conditions of the service instance.

2. The routing apparatus of claim 1, wherein the path setting unit determines whether the service and network conditions satisfy predefined conditions, and then controls the service instance and the service request path.

3. The routing apparatus of claim 1, further comprising a service instance management unit configured to group at least one of the service instances which are previously registered in a repository into a service group, map the service name of the service group to one of the service instance, and manage the mapping information.

4. The routing apparatus of claim 3, wherein the repository stores service instance information about the service instance.

5. The routing apparatus of claim 4, wherein the service instance information includes a service instance ID used to identify the service instance, a name of a service group defined for each function of a service provided by the service instance, a functional property and description for the service name, service binding information for the service instance, and service performance indices for the service and the network.

6. The routing apparatus of claim 5, wherein the interface unit converts the service request in accordance with an interface format of the service instance and provides the converted service request to the service instance, and converts service results of the service instance in accordance with an interface format of the service group and provides the converted service results to the UE, based on the service binding information.

7. The routing apparatus of claim 6, further comprising a service execution management unit configured to cache the service results on the network, and to, if the service request is identical to the cached service results, provide the service results to the UE.

8. A routing method, comprising:
transferring a service request under a service name acquired via a UE;
searching for service instances for the service name on a network;
selecting at least one from among the found service instances, and transferring the user request; and
providing a service, provided by the selected service instance, to the UE.

9. The routing method of claim 8, further comprising:
grouping the service instance into a service group, the service instance including at least one previously registered service instance; and
mapping the service instance to the service name for the service group.

10. The routing method of claim 8, wherein said selecting at least one from among the found service instances is performed based on conditions of services provided by the service instances, and conditions of the network.
